(19) United States
(12) Patent Application Publication
(10) Pub. No.: US 2010/0126978 A1
(43) Pub. Date: May 27, 2010

(54) Under desk, safety foot warmer

(76) Inventor: Phyllis Dawn Semmes, Gladstone, OR (US)

Correspondence Address: MARK S. HUBERT P.C., 516 SE MORRISON- SUITE 1200, PORTLAND, OR, 97214, US

(21) Appl. No.: 11/323,362

(22) Filed: Dec. 29, 2005

(51) Int. Cl. H05B 1/00; H05B 3/34; H05B 1/02

(52) U.S. Cl. 219/217; 219/528; 219/494

(57) ABSTRACT

The present invention relates to an improved heating pad adapted for personal use to warm the owner's feet while seated at a desk. It has a bi layer ground insulation system to save energy and keep the temperature of contact materials far below the applicable fire regulations. It has an occupancy sensing capability linked to a shut off switch enhancing the safety margin. It's electrical power consumption is under 1500 W with most common usage in the 90-135 W range. These features make it ideal for use at the workplace.

### FIELD OF THE INVENTION

The present invention relates to an improved heating pad adapted for personal use under a desk to warm feet. It has an improved ground thermal insulation system and incorporates an automatic electronic shutoff system, thereby making it both safe and practical for use at the workplace or in a home office.

### BACKGROUND

The problem of office employees having cold feet while working has been resolved in a plethora of methods. There is a multitude of various space heaters and space heater designs that have been used. The vast majority of these tend to heat the space under the desk and draw moderate electrical loads. It is commonplace to see employees using miniaturized ceramic space heaters that use 800 to 1500 W of electricity.

These methods of warming feet are dangerous for many reasons. The elements can burn the skin if contacted. Most must be switched on and off manually and offer no protection against units that are knocked over. They can be placed too close to combustible materials. The heat losses to the proximate space are huge and much of the heat does not reach the worker's feet unless they position their feet temporarily in front of the device. They can easily be forgotten and left on, particularly when the worker leaves their desk momentarily then is sidetracked away from their desk for an extended period of time. The electrical draw of several of these can overload the building electrical circuits including cubical power distribution. They require constant attention to the settings. Insufficient air circulation under the desk can cause the thermal switch to regularly activate switching off the unit for a temporary period of time to protect the elements. Lastly, many of these are not used so as to meet fire prevention regulations. In fact, many transmit heat to the abutting flooring materials in excess of what fire codes allow.

The present invention is a planar, pad heater that incorporates a sensing device to turn off the unit when there is no movement of the user's lower body for an extended period of time. The pad has a two layer lower heat system comprising an insulated lower layer and a reflective bottom layer that accomplishes three tasks; it keeps the outer bottom surface of the pad cool, it acts as a thermal mass to allow the pad to radiate residual heat after shut off, and it helps reflect and drive the pad's heat toward the upper surface.

The advantages of this device are that it can run with a lower power consumption than a space heater while making the most efficient use of it's heat and minimizing the fire hazard potential. Such a device eliminates the pitfalls of the prior art and would be a welcome safe alternative to what the market now offers.

### SUMMARY OF THE INVENTION

The general purpose of the present invention, which will be described subsequently in greater detail, is to provide an economical, safe, energy efficient device to heat one's feet.

It has many of the advantages mentioned heretofore and many novel features that result in a new under desk foot warmer which is not anticipated, rendered obvious, suggested, or even implied by any of the prior art, either alone or in any combination thereof.

In accordance with the invention, an object of the present invention is to provide an improved under desk safety foot warmer that is simple in design, construction and operation.

It is another object of this invention to provide an improved under desk safety foot warmer that minimizes the potential for fire hazards both due to the transmission of a high temperature to abutting flooring, and due to inadvertent prolonged exposure of elevated temperatures to abutting flooring.

It is a further object of this invention to provide an improved under desk safety foot warmer that will automatically turn off when the user has not been present for a preset period of time.

It is still a further object of this invention to provide for a improved under desk safety foot warmer that is able to radiate residual stored heat for a short period after it has been turned off.

It is yet a further object of this invention to provide a improved under desk safety foot warmer that will only transmit heat in one direction thereby meeting all existing building codes for contact heater devices.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

Other objects, features and aspects of the present invention are discussed in greater detail below.

### BRIEF DESCRIPTION OF THE DRAWINGS

FIG. 1 is a perspective view of the preferred embodiment under desk foot warmer;

FIG. 2 is a perspective view of the preferred embodiment under desk foot warmer utilizing a manual heat control;

FIG. 3 is a partial cross sectional view of the preferred embodiment under desk foot warmer;

FIG. 4 is a partial cross sectional partial cut away view of the first alternate embodiment under desk foot warmer; and

FIG. 5 is a partial cross sectional view of the second alternate embodiment under desk foot warmer.

### DETAILED DESCRIPTION

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings.

The invention is capable of other embodiments and of being practiced and carried out in various ways. Also, it is to be understood that the phraseology and terminology employed herein are for the purpose of descriptions and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The present invention relates to an under desk electric foot warmer having an improved safety shut off system and superior insulating capabilities.

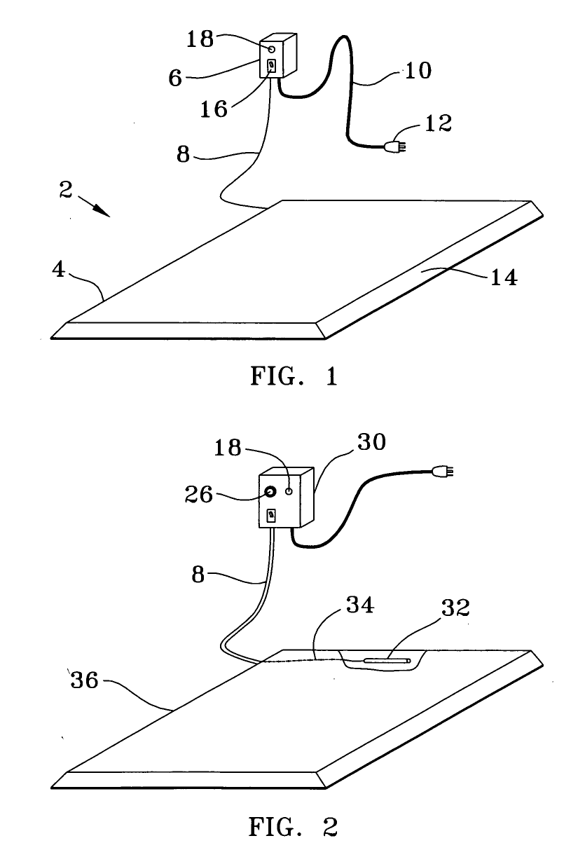

FIG. 1 illustrates the preferred embodiment under desk foot warmer. It is a generally planar, flexible but resilient heating pad 4 having a master control unit 6 which is electrically connected to heating pad 4 by control cable 8 and has electrical cord 10 with plug 12 affixed to the end of cord 10. The shape of pad 4 is generally rectangular having beveled edges 14 about the perimeter. The beveled edges 14 minimize the potential for the user to catch a foot or shoe on the pad 4. Control unit 6 has a power on/off switch 16 as well as an electrical switching motion detector 18 located therein.

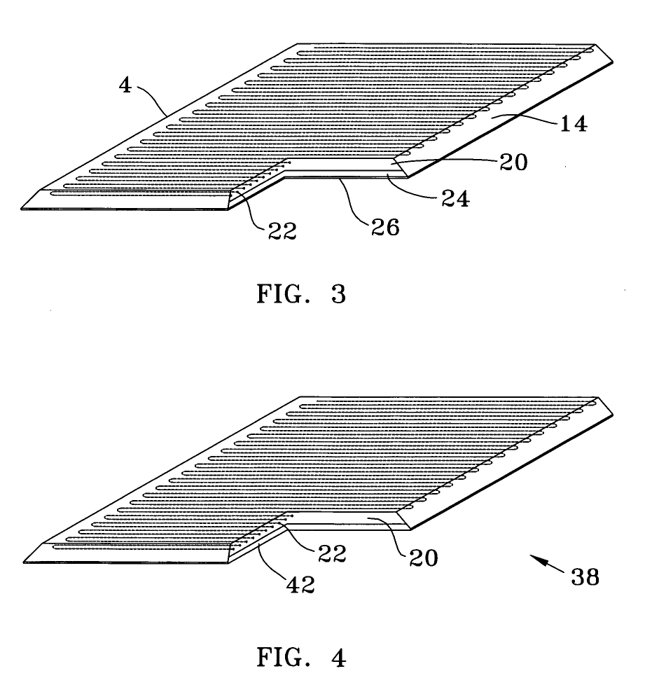

Referring to FIG. 3, a partial cross sectional view of the preferred embodiment, the three layer construction of pad 4 can be seen. The first layer 20 and the beveled perimeter edges 14 are made of the same heat resistant, waterproof, polymer material. Electrical conductor 22 is held in a patterned spatially position within the first layer 20. The first layer is the top side of the pad 4 being designed to face the underside of the user's desk. The third layer 26 is a resilient, flexible heat reflective foil layer that is affixed to the perimeter edges 14. There are several types of commercially available reflective foil substrates, well known in the industry, that are well suited for such an application. They may employ a single foil layer or a double foil layer bonded to and separated by a polymer bubble wrap. The foil layers may contain imbedded threads to form a stronger “rip stop” foil. The second layer 24 is a thermally insulating layer sandwiched between the first layer 20 and the third layer 26. Although the second layer is a fiberglass pad in the preferred embodiment, there are also numerous flexible insulating materials and fabrics such as closed cell foam pads, open cell foam pads, open cell sponges, Nomex®, Thinsulate™, Qualofil™, and related stitch-bonded, fibrous, nonwoven microfiber web fabrics, which are well known in the industry and would be an equivalent substitute for the fiberglass. The inclusion of the insulating layer allows the foot warmer to operate at a lowered power consumption.

FIG. 2 shows the preferred embodiment foot warmer with optional manual heat control 28 incorporated into the optional master control unit 30. Temperature sensing device 32 and signal wire 34 are imbedded into temperature controllable pad 36. Signal wire 34 extends to unit 30 within control cable 8.

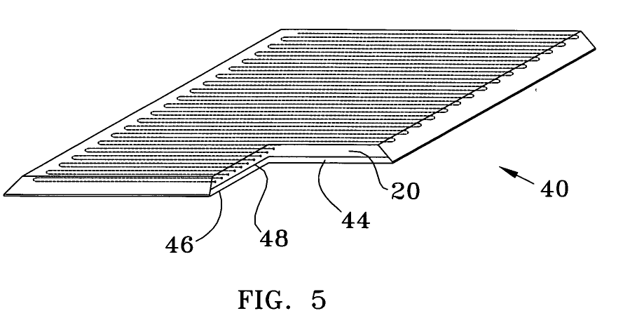

FIGS. 4, 5 and 6 illustrate the first, second and third alternate embodiment heating pads. These differ in the number of layers and the materials of construction of the various layers. The top layers of the first alternate embodiment pad 38 and second alternate embodiment pad 40 are identical to, and made of the same heat resistant, waterproof, polymer material as in the preferred embodiment. They also contain conductors 22 in the substantially same manner as does the preferred embodiment. The first alternate embodiment heating pad 38 has a bottom layer of a thermally insulating polymer 42 that is bonded to first layer 20 and serves to drive the heat upwards, and keep the bottom surface of the pad 38 cool while acting as a thermal mass to reduce the temperature swings of the pad. The second alternate embodiment heating pad 40 has a bottom layer made of an insulating and thermally reflective substrate that has two, flexible, resilient foil sheets 46 and 48 bonded to and separated by a sheet of polymer bubble wrap 44. This acts to reflect the heat of the pad upward and reflect the cold of the floor downward with the bubble sheet acting as a thermal barrier between the two foils.

In operation, the user places the pad, 4 foil side down, beneath their desk in the vicinity of their feet. Master control unit 6 is mechanically mounted under the desk and connected to a standard electrical outlet. When on/off switch 16 is switched to on electric current flows through conductor 22, (one selected that has a relatively high temperature coefficient of resistance). This generates heat, which is transmitted by conduction to the thermal mass of the heating pad 4 which in turn is radiated to the pad's contact surfaces and surrounding materials. Electric resistance heating converts nearly 100% of the energy in the electricity to heat. Resistance heating is a heat transfer technology which is ideal for such applications because it offers versatility, controllability and quick heat-up qualities. Generally, for this heating pad 4 application, the conductor 22 is a metal alloy ribbon, wire or strip heating element. Since the conductor 22 is imbedded and spatially arranged in the resilient yet flexible waterproof substrate first layer 20 as the conductor 22 heats up the surrounding mass of the first layer is evenly heated and radiates heat. Since the second layer 24 is an insulator little or no heat is transferred to the floor, and what little is transferred is reflected by the reflective foil third layer 26 back to the second layer 24 which also acts as a thermal mass. With the insulated design as described above, the warmer's power consumption will be under 800 watts with the most likely range of electrical power consumption in the 90-135 W range.

The motion detector 18 that can be used in the preferred embodiment may be selected from the group of motion detectors including but not limited to infrared, ultrasonic, microwave, acoustic proximity (radar), or capacitive proximity sensors. The use and application of each of these would be well know by one skilled in the art.

The motion detector 18 selected and most economical for use in the preferred embodiment is well known in the industry as a PIR (passive infrared) detector or pyroelectric sensor coupled to a commercially common appropriately sized (ampere rated) switching device. For this particular application the motion detector is configured to be sensitive to the temperature of a human body (having a skin temperature of about 93 degrees F., and radiating infrared energy with a wavelength between 9 and 10 micrometers) rather than the standard sensor, typically sensitive in the range of 8 to 12 micrometers. The motion detector 18 detects and monitors a change in heat as found from a warm human body. Once the temperature drops due to the absence of a user, the infrared detector 18 turns off the current to the pad 4. The motion detector 18 and/or master control unit 30, are mounted under the desk and angled so as to not “see” any thermal effect from the pad 4.

The temperature control can be accomplished in two ways. The preferred embodiment heating pad 4 uses a self-regulating heating conductor 22 that ambiently senses the pad 4 temperature and self-regulates the temperature. This acts as a safety feature and eliminates the need for a manual heat control 28.

Self-regulating conductors have a conductive polymer-heating element, such as a carbon matrix-heating element with variable resistance where the resistance exhibits a PTC (positive temperature coefficient) resistance characteristic and subsequently power output decreases with increasing temperature. As the temperature increases the conductor power output approaches zero. At this temperature the conductor effectively “shuts off”.

For larger models, the conductor will employ parallel resistance heating conductors that include a continuous series of short, independent heating circuits. In this way, localized damage will only result in partial loss of heating. In a parallel construction, the self-regulating heating conductor can adjust its power output for local condition along its length.

If a high temperature model is required the preferred embodiment pad 4 may utilize power limiting conductors, that is parallel resistance heating conductors that will reduce their power output as temperatures rise but do not have the high in-rush currents associated with self-regulating heating conductors. These conductors are capable of delivering high watt per foot heat outputs but as temperature increases do reach a “shut-off” temperature.

The second method of heat control utilizes manual heat control 28 which is incorporated into the optional master control unit 30. The preferred embodiment with optional heat control 28 maintains a tight, temperature control (one that does not wander or vary much from a specific set temperature value). It utilizes a temperature sensing device 32 and signal wire 34 which are imbedded into temperature controllable pad 36.

The manual heat control (thermostat) used to adjust the pad 4 temperature is a low-voltage thermostat which is well known to one skilled in the art. This type of device uses a relay to turn the foot warmer current on and off. The heat control 28 receives a temperature signal from a thermocouple or equivalent temperature sensing device 28. Such devices are well know in the industry.

It is well known that a line-voltage thermostat (the thermostat directly controls the power supplied to the heating device by the passage of current through a variable resistor) may also be used as an equivalent to the heat control 28. This type of temperature control is again incorporated into the master control unit but has no temperature sensing input. Rather it governs temperature by the amount of current flowing to the pad 4. The drawback therein is it they do not sense and thus control the pad temperature accurately.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed.

1. An electric foot warmer comprising:
a resilient, flexible, planar base having a two parallel ply construction with a top ply made of a heat resistant, waterproof, polymer, bonded to a bottom ply made of a heat reflective insulating material selected from the set of flexible, insulating materials consisting of fiberglass, closed cell foam pads, open cell foam pads, open cell sponges, and stitch-bonded, fibrous, nonwoven microfiber web fabrics;
at least one electrically conductive, resistive heat generating member, distributed therein said top ply of said planar base and wherein said conductive member is selected from the set of conductive members consisting of resistive ribbons, cables or strips;
an electrical power cord;
a control cable housing therein a signal cable and at least one electrical wire;
a temperature sensing device imbedded therein said planar base;
an adjustable temperature control thermostat to regulate the amount of electric current flowing to said conductor based on feedback received from said temperature sensing device;
a motion sensing device selected from the group of motion sensing devices comprised of infrared, ultrasonic, microwave, acoustic, or capacitive proximity sensors;
a power switch; and
a control unit housing said motion sensing device, said power switch and said temperature control thermostat;
wherein said power cord is connected to said control unit, said control unit is connected to said control cable and said signal cable is connected to said temperature sensing device located in said planar base and said electrical wires are connected to said electrically conductive member, and wherein said adjacent plies are of dissimilar materials.

2. (canceled)

3. (canceled)

4. The electric foot warmer of claim 1 wherein said control unit has a power switch and a motion sensing device adapted to allow electrical current to said conductive element only when in the proximity of a human and to stop electrical current to said conductive element whenever not in the presence of a proximate human.

5. The electric foot warmer of claim 1 wherein said motion sensing device is selected from the group of motion sensing devices comprised of infrared, ultrasonic, microwave, acoustic, or capacitive proximity sensors.

6. The electric foot warmer of claim 5 wherein said electrically conductive member is a self-regulating heating conductor that ambiently senses and self-regulates the conductive member's temperature.

7. The electric foot warmer of claim 5 wherein said control unit has a heat control unit adapted to regulate temperature of said foot warmer.

8. The electric foot warmer of claim 7 wherein said heat control unit comprises:
a temperature sensing device imbedded therein said planar base;
a signal cable housed therein said control cable; and
a thermostat incorporated therein said control unit and adapted to regulate the amount of electric current flowing to said conductor based on feedback received from said temperature sensing device.

9. The electric foot warmer of claim 7 wherein said heat control unit is a line voltage temperature control thermostat.

10. The electric foot warmer of claim 8 wherein said base has a two ply construction with a top ply made of a heat resistant, waterproof, polymer that houses said electrically conductive member, bonded to a bottom ply made of a heat reflective foil substrate.

11. The electric foot warmer of claim 8 wherein said base has a two ply construction with a top ply made of a heat resistant, waterproof, polymer that houses said electrically conductive member, bonded to a bottom ply made of a heat reflective, insulating polymer.

12. The electric foot warmer of claim 8 wherein said base has a two ply construction with a top ply made of a heat resistant, waterproof, polymer that houses said electrically conductive member, bonded to a bottom ply made of an insulating material selected from the set of flexible, insulating materials consisting of fiberglass, closed cell foam pads, open cell foam pads, open cell sponges, and stitch-bonded, fibrous, nonwoven microfiber web fabrics.

13. The electric foot warmer of claim 9 wherein said base has a two ply construction with a top ply made of a heat resistant, waterproof, polymer that houses said electrically conductive member, bonded to a bottom ply made of a heat reflective foil substrate.

14. The electric foot warmer of claim 9 wherein said base has a two ply construction with a top ply made of a heat resistant, waterproof, polymer that houses said electrically conductive member, bonded to a bottom ply made of a heat reflective, insulating polymer.

15. The electric foot warmer of claim 9 wherein said base has a two ply construction with a top ply made of a heat resistant, waterproof, polymer that houses said electrically conductive member, bonded to a bottom ply made of an insulating material selected from the set of flexible, insulating materials consisting of fiberglass, closed cell foam pads, open cell foam pads, open cell sponges, and stitch-bonded, fibrous, nonwoven microfiber web fabrics.

16. An electric foot warmer comprising:
a resilient, flexible, planar base having a cross sectional three layer construction wherein a top layer is made of a heat resistant, waterproof, polymer, a middle layer is made of a thermally insulating material and a bottom layer is made of a heat reflective foil substrate, bonded together into a multi plied construction;
at least one electrically conductive, resistive heat generating member, distributed therein said top ply of said planar base and wherein said conductive member is selected from the set of conductive members consisting of resistive ribbons, cables or strips;
an electrical power cord;
a control cable housing therein at least one electrical wire;
a line voltage temperature control device;
a passive infrared motion sensing device; and
a control unit, housing said motion sensing device, and said temperature control device,
wherein said cord is connected to said control unit, said control unit is connected to said control cable and at least one of said electrical wires within said control cable is connected to said electrically conductive member, wherein said passive infrared motion sensing device in conjunction with said line voltage temperature control device allows electrical current to flow to said conductive element.

17. (canceled)

18. (canceled)

19. (canceled)

20. The electric foot warmer of claim 18 wherein said control unit has a power switch and a passive infrared motion sensing device adapted to allow electrical current to said conductive element when in the proximity of a body having an approximate 93 degree F. skin temperature and radiating infrared energy with a wavelength between 9 and 10 micrometers, so as to stop electrical current to said conductive element in the absence of said body.
